(19) United States
(12) Patent Application Publication
(10) Pub. No.: US 2013/0185175 A1
(43) Pub. Date: Jul. 18, 2013

(54) USE OF USER-GENERATED CONTENT TO RANK PRODUCTS

(71) Applicants: Adam Roozen, Mankato, MN (US); Michael Braun, Lakeville, MN (US)

(72) Inventors: Adam Roozen, Mankato, MN (US); Michael Braun, Lakeville, MN (US)

(73) Assignee: ECHIDNA, INC., Minneapolis, MN (US)

(21) Appl. No.: 13/822,957

(22) PCT Filed: Sep. 13, 2011
(86) PCT No.: PCT/US11/51373

§ 371 Date: Mar. 13, 2013

Related U.S. Application Data
(60) Provisional application No. 61/382,360, filed on Sep. 13, 2010.

(51) Int. Cl. G06Q 30/06

(52) U.S. Cl. CPC G06Q 30/0629
USPC 705/26.64

(57) ABSTRACT

Product scores are generated for products. The product scores for the products are based on amounts of user-generated content (UGC) mentioning the products and based on how favorable the UGC is toward the products. A product comparison interface is provided to a consumer. The product comparison interface comprises product elements associated with at least some of the products. Each of the product elements comprises information about a different one of the products. The product comparison interface provides information about the product scores for the products associated with the product elements.

### BACKGROUND

Ecommerce is the buying and selling of products (e.g., goods and services) over electronic systems, such as the Internet or other computer networks. Ecommerce has made it easy for merchants to set up online shops. An online shop may sell several different products of the same type. For example, an online shop may sell many different types of televisions.

To ease the process of deciding which product to buy, many online shops allow users to submit feedback regarding products they have purchased. For example, an online shop can allow people to rate products on a scale of one to five. In another example, an online shop can allow people to enter written comments about products. In this way, people can see what other people think about the products.

Unfortunately, there are several drawbacks to the feedback submitted by people to online shops. For example, such comments and ratings tend to have a negative bias because people are more frequently motivated to submit feedback regarding a product when they are frustrated with the product than when they are happy with the product. In another example, a product may be sold in a large number of online shops and physical shops. Feedback regarding the product submitted to an online shop may only represent the sentiment of people who purchased the product from that online shop, not people who purchased the product from other online or physical shops. Hence, the feedback submitted to the online shop may not be representative of how a wider group of people feel about the product. In yet another example, the feedback submitted to an online shop may become obsolete if a provider of a product subsequently addresses problems with the product.

### SUMMARY

Product scores are generated for products. The product scores for the products are based on amounts of user-generated content (UGC) mentioning the products and based on how favorable the UGC is toward the products. A product comparison interface is provided to a consumer. The product comparison interface comprises product elements associated with at least some of the products. Each of the product elements comprises information about a different one of the products. The product comparison interface provides information about the product scores for the products associated with the product elements.

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example system.

FIG. 2 is a flowchart illustrating an example operation performed by an aggregation server.

FIG. 2A is a flowchart illustrating an example review extraction process according to one embodiment of the present invention.

FIG. 2B is a flowchart illustrating an example tag extraction process according to one embodiment of the present invention.

FIG. 3 is a flowchart illustrating an example operation performed by the aggregation server when a user creates a profile.

FIG. 4 is a flowchart illustrating an example operation performed by the aggregation server when one of the users is looking for a product.

FIG. 5 is a screen illustration showing an example search interface.

FIG. 6 is a screen illustration showing an example product comparison interface.

FIG. 7 is a screen illustration showing an example product detail interface.

FIG. 8 is a screen illustration showing an example sentiment correction interface.

FIG. 9 is a screen illustration showing an example map interface.

FIG. 10 is a screen illustration showing an example question submission interface.

FIG. 11 is a screen illustration showing an example wishlist interface.

FIG. 12 is a block diagram illustrating an example computing device.

### DETAILED DESCRIPTION

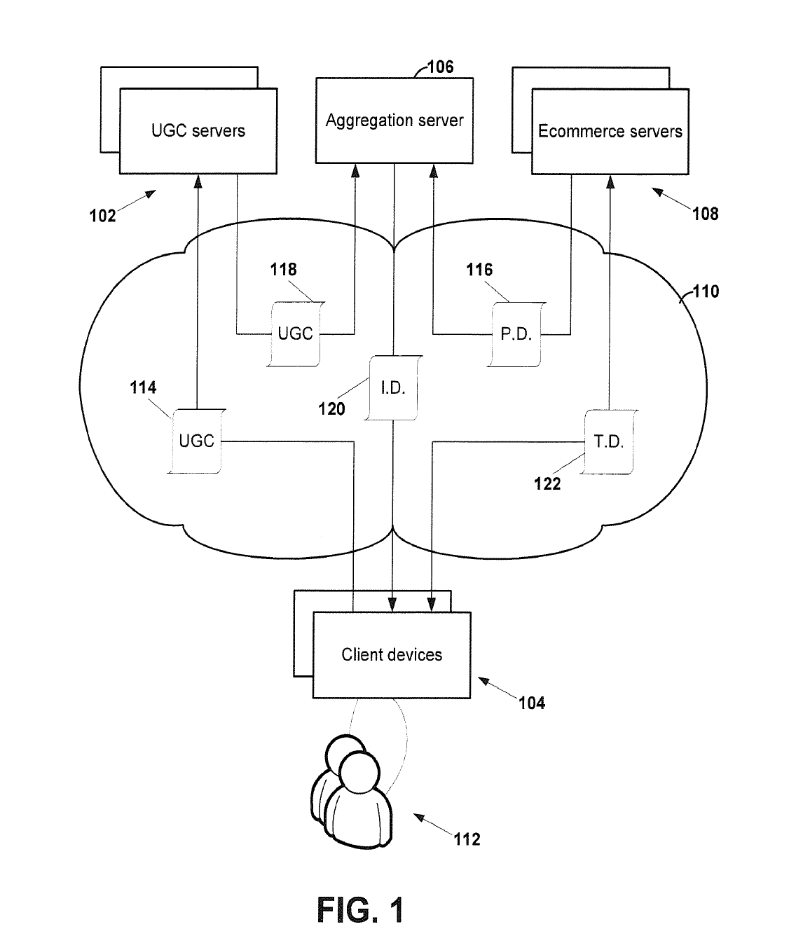

FIG. 1 is a block diagram illustrating an example system 100. As illustrated in the example of FIG. 1, the system 100 comprises a set of User-Generated Content (UGC) servers 102, a set of client devices 104, an aggregation server 106, a set of ecommerce servers 108, and a network 110. The UGC servers 102, the client devices 104, the aggregation server 106, and the ecommerce servers 108 are computing systems.

The network 110 facilitates communication among the UGC servers 102, the client devices 104, the aggregation server 106, the client devices 104, and the ecommerce servers 108. In various embodiments, the network 110 can be various types of networks. For example, the network 110 can be a wide area network, such as the Internet. In another example, the network 110 can be a local area network, a virtual private network, or another type of communications network. The network 110 can include wired and/or wireless communication links.

The ecommerce servers 108 are systems of computing devices that provide ecommerce services. The ecommerce services enable people to buy products, such as goods or services, over the network 110. To facilitate the buying of products over the network 110, the ecommerce servers 108 enable the client devices 104 to retrieve product information via network 110. The product information describes the products. In addition, the ecommerce servers 108 can enable the users to place orders for the products.

The UGC servers 102 are systems of computing devices that provide UGC services. The UGC services store and distribute user-generated content. The UGC services can include microblogging services, such as Twitter, Tumblr, Plurk, identi.ca, Emote.in, Beeing, Jaiku, and so on. Furthermore, the UGC services can include social networking services, such as Facebook, MySpace, Orkut, Friendster, LinkedIn, Qzone, and so on. Furthermore, the UGC services can include media sharing sites, such as YouTube, Flickr, Picasa, and so on. Furthermore, the services provided by the UGC servers 102 can include blogging services, such as Blogger, LiveJournal, Google Blogs, and so on.

As illustrated in the example of FIG. 1, the system 100 also comprises a set of users 112. The users 112 use the client devices 104 to access the UGC servers 102. The client devices 104 can be a variety of different types of computing devices. For example, the client devices 104 can be desktop computers, workstation computers, video game consoles, television set top boxes, network-connected televisions, or other types of computing devices. Furthermore, the client devices 104 can be mobile computing devices, such as smartphones (e.g., Apple iPhones, Motorola Driod phones), tablet computers (e.g., Apple iPads), personal media players (e.g., Apple iPods, Microsoft Zune players), in-vehicle computing systems, laptop computers, netbook computers, or other types of computing devices designed to be mobile.

At least some of the users 112 use the UGC services provided by the UGC servers 102 to generate and distribute content 114. To use the UGC services, the users 112 establish UGC accounts with the UGC services. For example, the users 112 can establish Facebook profiles with the Facebook service. After establishing UGC accounts with the UGC services, the users 112 publish the content 114 through the UGC accounts. For example, the users 112 can use their Twitter accounts to publish tweets. In another example, the users 112 can use their Facebook accounts to publish status updates.

Some of the users 112 generate content using multiple ones of the UGC services provided by the UGC servers 102. For example, one of the users 112 can generate tweets using Twitter and can generate status updates using Facebook. Furthermore, some of the users 112 can generate content using multiple profiles on the same UGC service. For example, one of the users 112 can generate tweets about professional matters using one Twitter account and can generate tweets about personal matters using another Twitter account. In another example, one of the users 112 can use one of the UGC services to manage two or more separate blogs.

The aggregation server 106 is a system of one or more computing devices that provides a product rank service. In some embodiments, the entity that provides the product rank service is different than the entities that provide the UGC services of the UGC servers 102 and the ecommerce services of the ecommerce servers 108. As described in detail elsewhere in this document, the product rank service of the aggregation server 106 retrieves product data 116 from the ecommerce servers 108. The product data 116 comprises data that describes products sold through the ecommerce servers 108. For example, the product data 116 can comprise data about different televisions sold through the ecommerce servers 108.

When the aggregation server 106 retrieves the product data 116 from the ecommerce servers 108, the aggregation server 106 analyzes the product data 116 to associate tags with products described by the product data 116. The tags comprise words or phrases associated with the products described by the product data 116. For example, the product data 116 can describe a 32-inch LCD TV by Sony. In this example, the aggregation server 106 can associate the tags “32-inch,” “LCD,” “TV”, and “Sony” with this product.

Furthermore, the aggregation server 106 allows the users 112 to create profiles. A user's profile lists UGC accounts that the contributor uses to generate and distribute content. For example, a given user's profile can list a Facebook account, two blog accounts, and a Twitter account. When the users 112 list UGC accounts in their profiles, the users 112 grant the aggregation server 106 rights to retrieve the user-generated content in the UGC accounts. After the users 112 grant the aggregation server 106 rights to retrieve user-generated content in their UGC accounts, the aggregation server 106 communicates with the UGC servers 102 to retrieve such user-generated content 118 from the UGC servers 102.

The aggregation server 106 analyzes the user-generated content 118 to identify feedback items. The feedback items are user-generated content items that mention products. To identify feedback items, the aggregation server 106 identifies user-generated content items that include tags associated with products described in the product data 116. For example, the aggregation server 106 can identify tweets, status updates, and blog posts that include the words “Sony” and “TV.” In addition, the aggregation server 106 analyzes each identified feedback item to determine whether the feedback item expresses favorable sentiment toward product mentioned in the feedback item.

The aggregation server 106 generates product scores for products described in the product data 116 based on numbers of feedback items for the products and based on whether the feedback items for the products are favorable toward the products. In general, a product has a high product score if there are a large number of feedback items for the product and the feedback items for the product generally express favorable sentiment toward the product. In contrast, a product has a low product score if there are not many feedback items for the product and the feedback items for the product express negative sentiment toward the product.

To ease the process of finding products that the users 112 want to buy, the users 112 use the client devices 104 to retrieve interface data 120 from the aggregation server 106. The client devices 104 use the interface data 120 to display a product comparison interface to the users 112. The product comparison interface comprises product elements. The product elements contain information about the products described in the product data 116. Furthermore, the product comparison interface provides information about the product scores for the products described in the product data. For example, the product elements in the product comparison interface can be ordered based on the relative product scores of the products associated with the product elements. In another example, the product elements can specify the product scores of the products associated with the product elements.

The product ranks of the products can help the users 112 decide which of the products they want to buy. For example, the users 112 may want to buy products that have high product scores as opposed to low product scores because many people are saying favorable things about the products having high product scores. When the users 112 decide to buy products, the client devices 104 exchange transaction data 122 with the ecommerce servers 108. The transaction data 122 represent details of a purchase transaction between the users 112 and the entities operating the ecommerce services provided by the ecommerce servers 108.

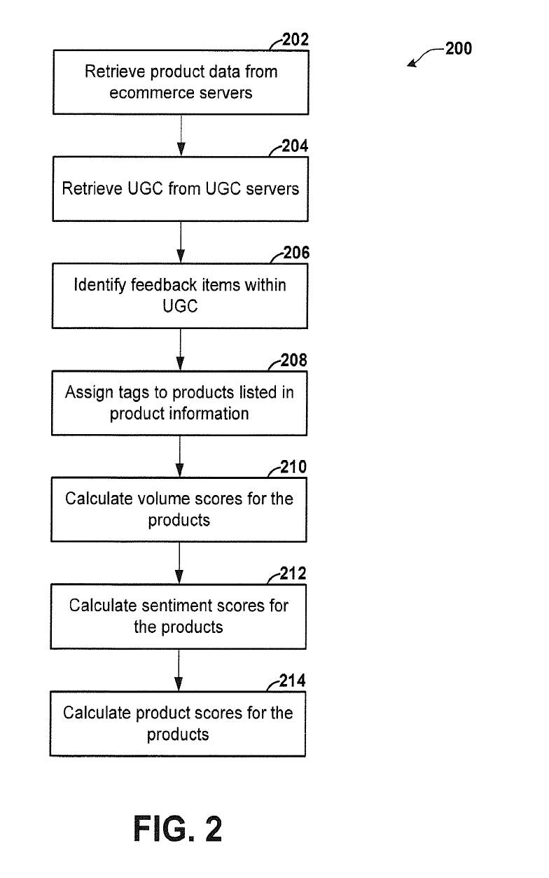

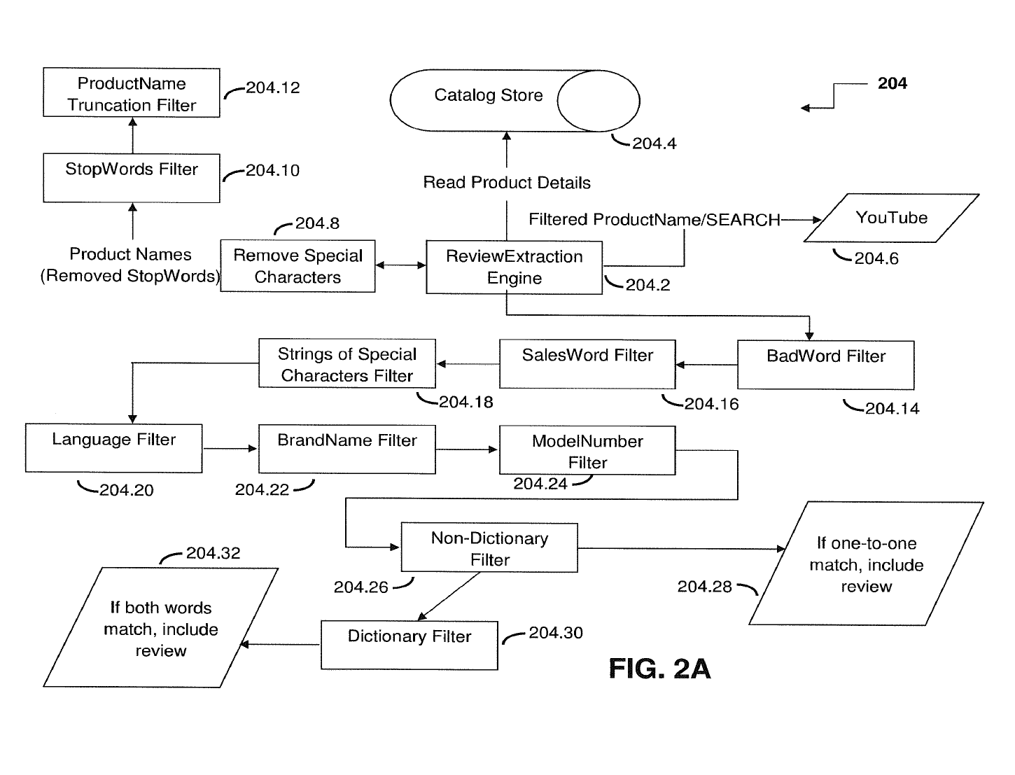

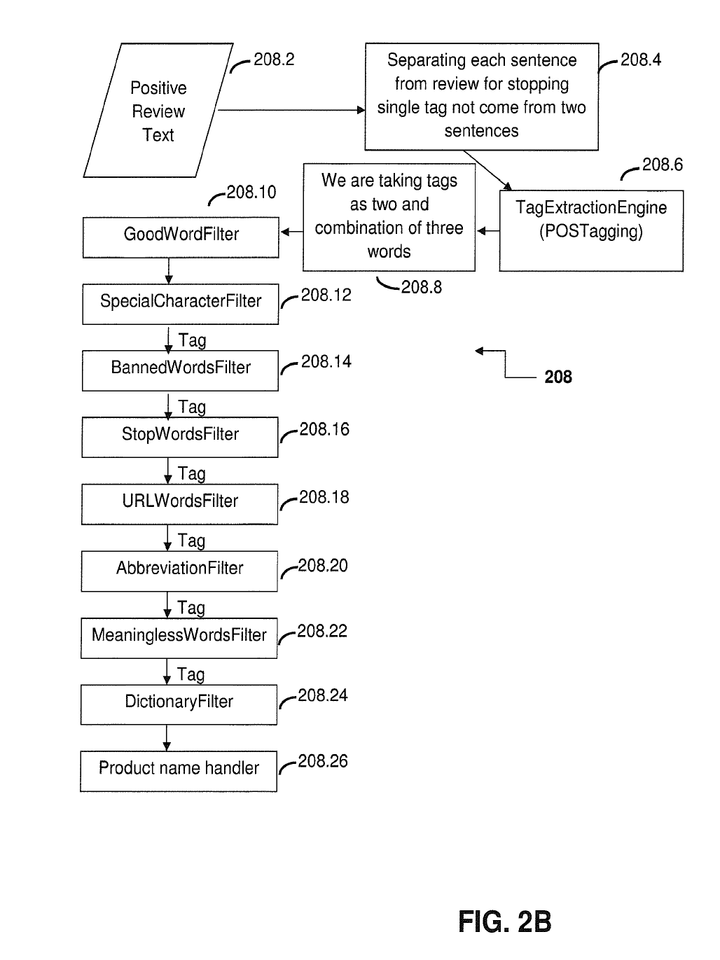

FIG. 2 is a flowchart illustrating an example operation 200 performed by the aggregation server 106. As illustrated in the example of FIG. 2, the operation 200 begins when the aggregation server 106 retrieves the product data 116 from the ecommerce servers 108 (202). As discussed above, the product data 116 comprises data that describes products sold through the ecommerce servers 108.

For example, the product data 116 can include the product numbers of the products. In this example, the product data from a first one of the ecommerce servers 108 can describe a product having a product number and the product data from a second one of the ecommerce servers 108 can describe a product having the same product number. In this example, the aggregation server 106 uses the product numbers to determine that the same product is being sold through the first and second ecommerce servers. For instance, the aggregation server 106 can determine that a first online shop and a second online shop are both selling the same 42-inch Sony Bravia television.

In another example, the product data 116 can include detailed specifications for the products. In this example, the product data 116 for a television can include the resolution, screen refresh rate, the bit depth, the warranty terms, the number of HDMI inputs, the width, the height, the contrast ratio, and so on. In another example, the product data 116 can include the prices of the products.

The product data 116 can include various types of information about the products. In various embodiments, the product data 116 can be formatted in various ways. For example, the product data 116 can be formatted as XML data. In another example, the product data 116 can be formatted as one or more files comprising comma-separated values.

In other embodiments, the aggregation server 106 does not retrieve the product data 116 from the ecommerce servers 108. Rather, in such embodiments, the aggregation server 106 retrieves the product data 116 from one or more third-party services that aggregate product data from the ecommerce servers 108 or other sources.

Furthermore, the aggregation server 106 retrieves the user-generated content 118 from the UGC servers 102 (204). As discussed briefly above, the users 112 grant the aggregation server 106 the right to access some or all content in the UGC accounts owned by the users 112. The aggregation server 106 only retrieves user-generated content from UGC accounts that the aggregation server 106 has a right to access. The aggregation server 106 can also retrieve user-generated content from UGC accounts that are accessible to the general public, such as unprotected Twitter feeds and public blogs. The user-generated content 118 can be formatted in various ways. For example, different UGC services can provide the user-generated content 118 in various formats, such as XML, HTML, comma-separated values, text, or another format.

After retrieving the user-generated content 118 from the UGC servers 102, the aggregation server 106 identifies feedback items within the user-generated content 118 (206). The feedback items are pieces of user-generated content that mention the products. For example, a tweet that mentions one of the products is a feedback item. In this example, a blog post that mentions the product is another feedback item.

In some instances, individual user-generated content items are not specific enough to determine that they mention an individual product. For example, a tweet includes the text “My new Sony television is great!” In this example, the product data 116 can include data describing several different Sony televisions. In this example, the tweet is not specific enough to determine that the tweet mentions an individual one of the Sony televisions. In instances where a user-generated content item relates to a related set of products, but is not specific to an individual product, the aggregation server 106 identifies the user-generated content items as being a feedback item for each of the products in the related set of products. In the previous example, the aggregation server 106 identifies the tweet as being a feedback item for each Sony television described in the product data 116.

Next, the aggregation server 106 assigns tags to the products described in the product data 116 (208). In some embodiments, the aggregation server 106 assigns a tag to a product when the percentage of feedback items mentioning the product exceeds a given threshold. For example, the aggregation server 106 can assign the tag “high def” to a given type of television if more than 10% of feedback items mentioning the given type of television include the phrase “high def.” By assigning tags to products, the aggregation server 106 assembles a tag cloud for each of the products described in the product data 116. As described elsewhere in this document, the users 112 can, in some embodiments, refine the tag clouds for the products by providing input to the aggregation server 106 to add or remove tags from the tag clouds.

Next, the aggregation server 106 calculates volume scores for the products described in the product data 116 (210). The volume score for a product is a measure of an amount of user-generated content mentioning the product. In various embodiments, the aggregation server 106 calculates the volume scores for products in various ways. For example, the aggregation server 106 can calculate an average amount of UGC for a set of products. In this example, the aggregation server 106 then calculates, for each product in the set of products, how many standard deviations the amount of UGC for the product is away from the average amount of UGC for the set of products. In this example, the set of products can be some or all of the products described in the product data 116. In another example, the aggregation server 106 can apply a set of business rules that govern how the aggregation server 106 calculates the volume scores of the products.

The aggregation server 106 then calculates sentiment scores for the products (212). The sentiment score for a product is a measure of how favorable the user-generated content mentioning the product is toward the product. In various embodiments, the aggregation server 106 determines whether the feedback items express positive, negative, or neutral sentiment toward the products in various ways. For example, the aggregation server 106 can first determine whether a feedback item is noise or spam. A feedback item is noise when the feedback item is not relevant as an indicator of a value of a product. For example, the aggregation server can consider advertisements to be noise. A feedback item is spam when the feedback item is redundant or malicious. The aggregation server 106 does not consider the sentiment expressed by noise or spam feedback items.

In this example, the aggregation server 106 then applies an algorithm to each of the remaining feedback items to obtain sentiment scores and confidence scores for the feedback items. In some embodiments, the sentiment scores are on a scale of −100 to +100, with −100 indicating very negative sentiment and +100 indicating very positive sentiment. The confidence scores for the feedback items indicate how much confidence the aggregation server 106 attaches to the sentiment scores. For example, a feedback item can have a sentiment score of 57. In this example, the feedback item can have a high confidence score if the aggregation server 106 is very confident that the sentiment score of 57 is appropriate for the feedback item or a low confidence score if the aggregation server 106 is not very confident that the sentiment score of 57 is appropriate for the feedback item. In some embodiments, the confidence scores for feedback items are used as weights for the sentiment scores for the feedback items.

In various embodiments, the algorithm can be implemented in various ways. For example, the algorithm can be implemented using a neural network algorithm, association rule algorithm, a decision tree learning algorithm, a Bayesian network algorithm, or another algorithm.

After calculating the volume scores and the sentiment scores for the products, the aggregation server 106 calculates product scores for the products (214). The product score for a product is based, at least in part, on the volume score for the product and the sentiment score for the product. In various embodiments, the aggregation server 106 calculates the product scores for the products in various ways. For example, the aggregation server 106 can calculate the product score for a product by adding together the volume score for the product and the sentiment score for the product. In another example, the aggregation server 106 can calculate the product score for a product by multiplying the volume score for the product and the sentiment score for the product. In either of these examples, the aggregation server 106 can apply weights to either the volume score for the product or the sentiment score for the product.

FIG. 2A is a flowchart illustrating an example review extraction process 204 according to one embodiment of the present invention. A review extraction engine 204.2 acts to retrieve user-generated content 118 from the UGC servers 102 and determine whether the user-generated content 118 will be included as a review using various filters. All characters except a-z, A-Z, 0-9 are considered as special characters and are removed from the review (204.8). A stop words filter 204.10 removes words from the product name if they are present as part of the stop words list. A product name truncation filter 204.12 acts to perform the following functions: truncate product name to ten words if it is longer; truncate product name to five words and find matching reviews; truncate product name to four words and find matching reviews; truncate product name to three words and find matching reviews; and use synonyms, if found in synonym dictionary, and find matching reviews.

When a review is selected by the review extraction engine 204.2, it is fed through various filters to determine whether words or items will be included in the review. A bad word filter 204.14 will reject any review that contains words determined to be undesirable, or bad words. A language filter 204.20 acts to reject any review that consists of 50% or more non-dictionary words. Other filters used during the review extraction process 204 include a sales word filter 204.16, a strings-of-special-characters filter 204.18, a brand name filter 204.22, and a model number filter 204.24.

A non-dictionary filter 204.26 performs a one-to-one match in the review for words in a product name that are not in a dictionary and are not brand words. If there is a one-to-one match, the review is included (204.28). If the review content matches with any of the synonyms of the product, the review is matched and proceeds to a dictionary filter 204.30. For words in dictionary, brand words, or custom dictionary words, the word is combined with the next word in the product name. A search is then performed for the presence of this word-pair or its synonyms in the review. If both words match, the review is included (204.32).

FIG. 2B is a flowchart illustrating an example tag extraction process 208, according to one embodiment of the present invention. In the process, each sentence of positive review text 208.2 is separated to prevent a single tag from being assembled from two or more separate sentences (208.4). A tag extraction engine 208.6 will consider only the following word types when extracting tags to assign to products described in the product data 116: adjectives, comparative adjectives, superlative adjectives, adverbs, comparative adverbs, superlative adverbs, singular nouns, plural nouns, singular proper nouns, plural proper nouns, base form verbs, gerund or present participle verbs, past tense verbs, non-3^{rd} person singular present verbs and 3^{rd} person singular present verbs. The tag extraction engine 208.6 then assigns tags as two and a combination of three words (208.8).

The tag extraction engine 208.6 contains filters that act to reject certain words or items when creating tags to assign to products, or that reject the tag entirely based on the conditions of the filter. If some positive feedback words are rejected by the tag extraction engine 208.6 then they are being matched with the good word filter 208.10. If a tag starts with special characters or contains special characters between words, the entire tag will be removed by a special character filter 208.12. All characters except a-z, A-Z, 0-9 are considered as special characters and will cause the special character filter 208.12 to remove the tag. A banned word filter 208.14 captures and removes any bad words listed at certain pre-determined web pages. A stop words filter 208.16 captures a set of stop words and removes each particular word if the review text 208.2 contains any. A URL Words Filter 208.18 captures a set of URL-related words and applies a filter to remove each particular word if any are present. An abbreviation filter 208.20 captures a set of suffixes or short hand words and applies a filter to remove the entire tag if it contains any.

A meaningless words filter 208.22 removes only single-letter words but retains the remaining words which are part of the tag. This filter also checks the length of the entire tag; if the length is less than two words, it does not satisfy the condition and the entire tag is removed. Further, the meaningless words filter 208.22 removes any tag that is entirely numeric, a repetition of the same letters, or a continuous repetition of words. The meaningless words filter will not remove a tag with a repetition of words that is not continuous (example: “Alarm Alarm” will be removed, but “Alarm Black Alarm” will not).

A dictionary filter 208.24 will check the words in a tag against a dictionary definition. If the dictionary contains a definition for each particular word, the tag will be retained; if the dictionary does not contain a definition for each particular word, the tag will be removed by this filter. If two consecutive words in the tag are matching with a product name, the tag will be removed by a product name handler 208.26.

Any tags that are not removed by the aforementioned filters will be assigned by the aggregation server 106 to the products described in the product data 116, given that the product feedback items conform to the previously discussed conditions for assignment of a product tag.

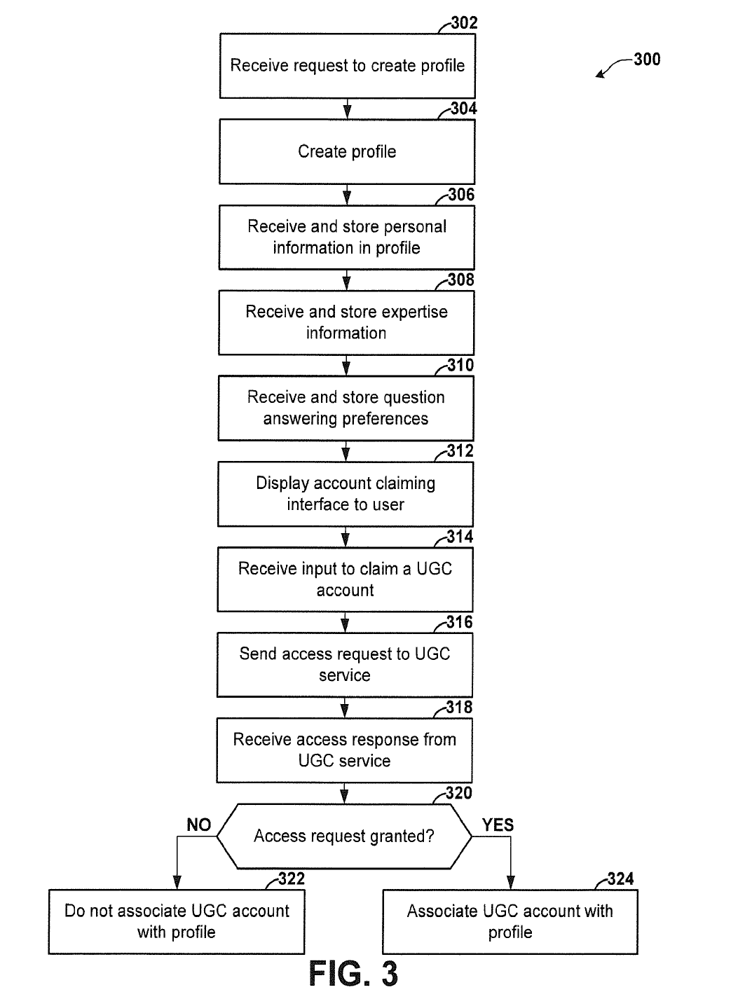

FIG. 3 is a flowchart illustrating an example operation 300 performed by the aggregation server 106 when a user creates a profile. As illustrated in the example of FIG. 3, the operation 300 begins when the aggregation server 106 receives a request to create a profile (302). In various embodiments, the aggregation server 106 can receive a request to create a profile in various ways. For example, in some embodiments, the aggregation server 106 receives a request to create a profile via a web site. In response, the aggregation server 106 creates a profile for the user (304). After the aggregation server 106 creates a profile for the user, the aggregation server 106 receives personal information about the user and stores the personal information with the profile (306). The personal information can include a user name, an email address, biographical information, geographical information, gender, age, credit or debit card information, and/or other personal information about the user.

Furthermore, the aggregation server 106 receives and stores expertise information with the profile (308). The expertise information indicates topics in which the user claims to be an expert. For example, the expertise information can indicate that the user claims to be an expert in televisions and archery. As discussed elsewhere in this document, the aggregation server 106 can use the expertise information to route community questions to the user. Community questions are questions posed by users of the product rank service provided by the aggregation server 106 to the community of users of the product rank service.

In addition, the aggregation server 108 receives and stores question answering preferences with the profile (310). The question answering preferences indicate whether or how frequently the user would like to receive questions from other users. For example, the question answering preferences can indicate that the user does not want to receive more than two questions per day. As discussed elsewhere in this document, the aggregation server 106 does not route a community question to the user if the user's question answering preferences indicate that the user does not want to receive the community question.

Initially, the profile is not associated with any UGC accounts. Accordingly, the aggregation server 106 displays an account claiming interface to the user (312). The account claiming interface is a user interface that includes controls that allow the user to claim one or more UGC accounts as belonging to the user. For example, the account claiming interface can comprise controls that allow the user to claim Twitter accounts, blogs, Facebook profiles, MySpace pages, YouTube channels, or other UGC accounts. The account claiming interface, or another interface, informs the user that the aggregation server 106 will access content in the user's claimed UGC accounts.

To display an interface to the user, the aggregation server 106 sends the interface data 120 to one of the client devices 104 used by the user. In various embodiments, the interface data 120 is formatted in different ways. For example, the interface data 120 is formatted as HTML. In another example, at least some of the interface data 120 is formatted as XML. In this example, the client devices 104 can retrieve the XML using AJAX technology. In yet another example, at least some of the interface data 120 is formatted as Adobe Flash or HTML5 data. The aggregation server 106 does not necessarily send all of the interface data 120 in response to a single request from the client devices 104. Rather, the aggregation server 106 can send the interface data 120 to the client devices 104 in response to multiple requests sent by the client devices 104 over time.

Subsequently, the aggregation server 106 receives input from the user to claim a UGC account (314). For example, the aggregation server 106 can receive input from the user to claim a Twitter account. In response to receiving the input to claim the UGC account, the aggregation server 106 sends an access request to a UGC service that provides the UGC account (316). The access request is a request by the aggregation server 106 to access the UGC account. For example, the access request can be a request to Facebook for access to the user's status updates. In some instances, the UGC service can prompt the user for authentication credentials before granting the access request. For example, Facebook may prompt the user to provide a username and password before allowing the aggregation server 106 to access the user's status updates.

Subsequently, the aggregation server 106 receives an access response from the UGC service (318). The access response indicates whether the aggregation server 106 has been granted access to the UGC account. In response to receiving the access response, the aggregation server 106 determines whether the access response indicates that the UGC service granted the access request (320). If the UGC service did not grant the access request (“NO” of 320), the aggregation server 106 does not associate the UGC account with the profile (322). Otherwise, if the UGC service granted the access request (“YES” of 320), the aggregation server 106 associates the UGC account with the profile (324).

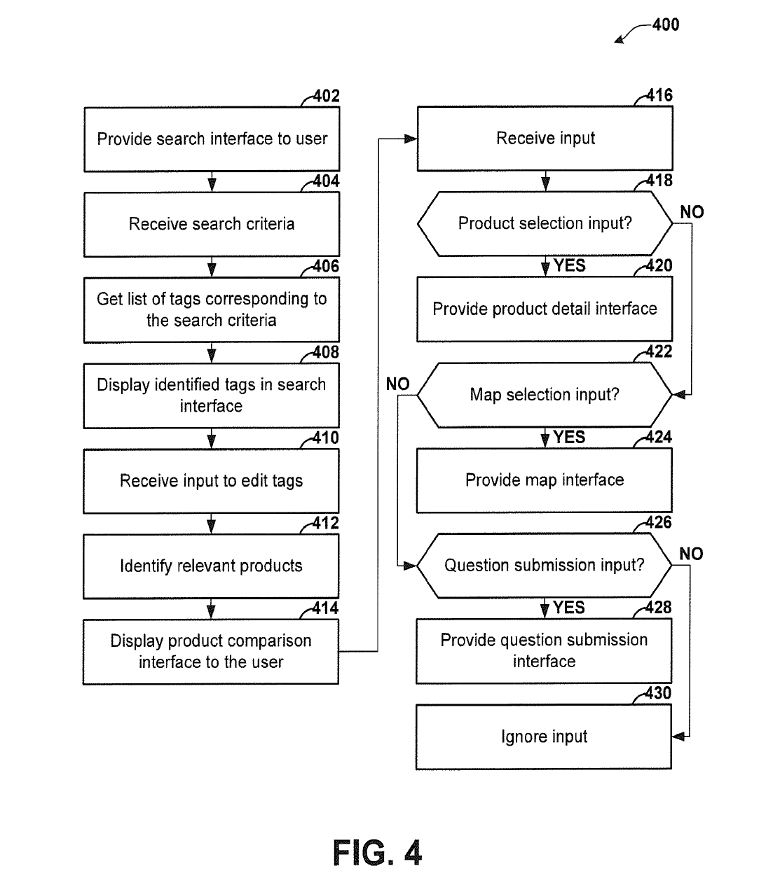

FIG. 4 is a flowchart illustrating an example operation 400 performed by the aggregation server 106 when one of the users 112 is looking for a product. As illustrated in the example of FIG. 4, the operation 400 starts when the aggregation server 106 provides a search interface to the user (402). After the aggregation server 106 provides the search interface to the user, the aggregation server 106 receives one or more search criteria inputted by the user via the search interface (404). In various embodiments, the aggregation server 106 can receive the search criteria in various ways. For example, the aggregation server 106 can receive the search criteria after the user types the search criteria into a text area in the search interface.

In response to receiving the search criteria, the aggregation server 106 identifies tags that correspond to the search criteria (406). For example, the aggregation server 106 can receive the search criterion “television.” In this example, the aggregation server 106 can identify the tags “LCD,” “plasma,” “high-definition,” “LED,” and “bright room” as corresponding to the search criterion “television.” The aggregation server 106 then displays the identified tags in the search interface (408).

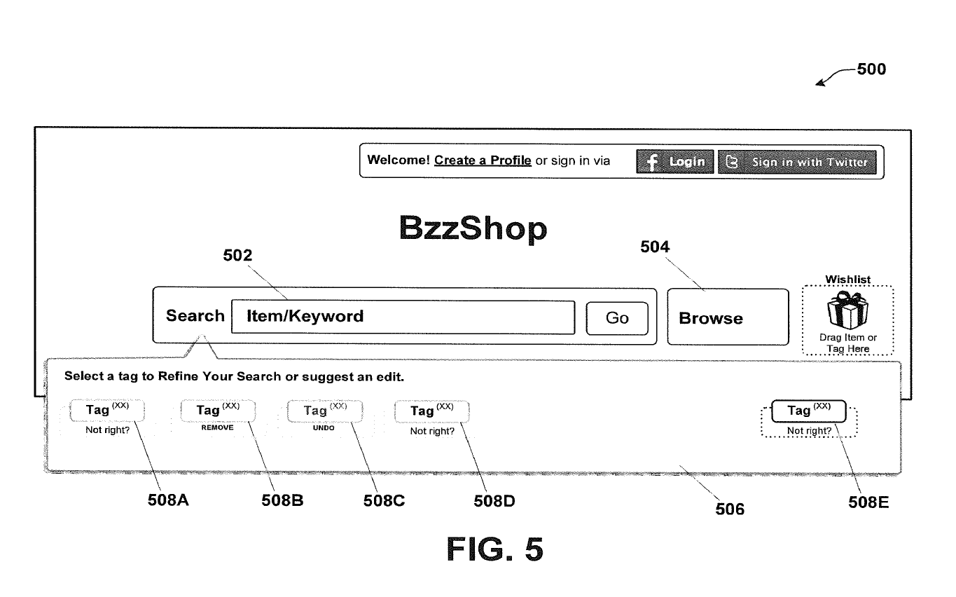

FIG. 5 is a screen illustration showing an example search interface 500. In various embodiments, the search interface can have various styles and functionalities. It should be appreciated that the search interface can have a different style and different functionality than the search interface 500.

As illustrated in the example of FIG. 5, the search interface 500 comprises a search box 502. The user can input one or more search criteria into the search box 502. For example, the user can type the terms “plasma” and “TV” into the search box 502. Alternately, the user can select a browse button 504. When the user selects the browse button 504, the search interface 500 displays a list of product categories, such as “automotive,” “beauty,” “camping,” “plumbing,” “electronics,” and so on. The user can input one or more search criteria by selecting one or more of these categories as search criteria. Alternatively, the user can expand one or more of the categories. When the user expands one of the categories, the search interface 500 displays a list of sub-categories within the category. For example, if the user selected the “television” category, the search interface 500 can display sub-categories such as “computers,” “phones,” “televisions,” “DVRs,” and so on. The user can then input one or more search criteria by selecting one or more of these sub-categories.

In some embodiments, products are organized into hierarchical categories. For example, LCD televisions and plasma televisions can be in a “television” category and the “television” category can be in an “electronics” category. In some of these embodiments, when a tag is assigned to a product by the aggregation server 106, a user, or another entity or device, the aggregation server 106 automatically assigns the tag to each category that directly or indirectly includes the product. Continuing the previous example, if the tag “1040p” is assigned to an LCD television, the aggregation server 106 assigns the tag “1040p” to the “television” category” and the “electronics” category. In this way, tag clouds develop around the categories.

After the user inputs one or more search criteria into the search box 502 or selects one or more categories, the search interface 500 displays a tag editing interface 506 contains tag elements 508A through 508E (collectively, “tag elements 508”). The tag elements 508 correspond to tags in the tag clouds of each of the search criteria or the selected categories. For example, if the search criteria are “television” and “LCD,” the tag elements 508 would correspond to tags that are in the tag cloud for the term “television” and also in the tag cloud for the term “LCD.”

When the aggregation server 106 displays the identified tags in the search interface, the aggregation server 106 can receive input to edit the identified tags (410). For example, the aggregation server 106 can receive input to remove one or more of the identified tags. The tag editing interface 506 allows the user to remove tags. When the user removes a tag from the tag editing interface 506, products that only have that tag fall out of a result set. The result set is a set of products described in the product data 116 that have one or more of the tags. Thus, by progressively removing tags that are inapplicable to a product of interest, the user can narrow the search toward the product of interest. For example, the identified tags can include two tags: “1040p” and “720i.” In this example, the result set includes products that have the tag “1040p” and products that have the tag “720i.” In this example, the user can remove the tag “720i.” In this example, the result set only includes products with the tag “1040p.” In this way, the user can indicate that he or she is not interested in televisions with 720i vertical resolution. In this document, the term “search tags” refers to the tags that remain after the user edits the identified tags.

Reference is now made again to FIG. 4. After the aggregation server 106 receives input from the user to edit the tags, the aggregation server 106 uses the search tags to identify relevant products (412). A product is a relevant product when one or more of the search tags have been assigned to the product.

Next, the aggregation server 106 displays a product comparison interface to the user (414). The product comparison interface comprises product elements. Each of the product elements comprises information about a different one of the relevant products. The product comparison interface provides information about the product scores for the products associated with the product elements.

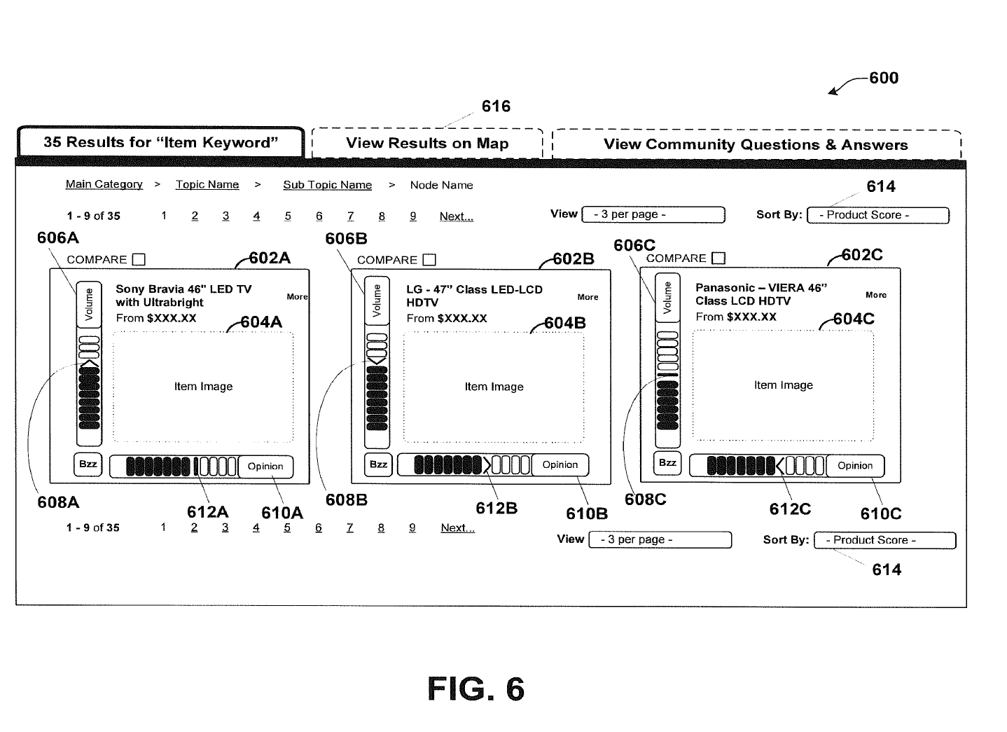

In various embodiments, the product comparison interface has various elements and styles. FIG. 6 is a screen illustration showing an example product comparison interface 600. It should be appreciated that in other embodiments, the product comparison interface can have elements and styles different than those of the product comparison interface 600.

As illustrated in the example of FIG. 6, the product comparison interface 600 includes product elements 602A through 602C (collectively, “product elements 602”). Each of the product elements 602 contains information about a different one of the relevant products. For example, the product element 602A contains information about the product “Sony Bravia 46″ LED TV with Ultrabright,” the product element 602B contains information about the product “LG-47″ LED-LCD HDTV,” and the product element 602C contains information about the product “Panasonic-VIERA 46″ Class LCD HDTV.” The product elements 602 include images 604A through 604C (collectively, “images 604”). The images 604 are pictures of the products associated with the product elements 602.

The product elements 602 also include volume bars 606A through 606C (collectively, “volume bars 606”). The volume bars 606 contain information about the volume scores of the products associated with the product elements 602. Particularly, in the example of FIG. 6, the volume bars 606 have more black boxes when the products associated with the product elements 602 have higher volume scores. Conversely, the volume bars 606 have fewer black boxes when the products associated with the product elements 602 have lower volume scores.

In addition, the volume bars 606 include volume trend indicators 608A through 608C (collectively, “volume trend indicators 608”). The volume trend indicators 608 indicate whether the volume scores for the products associated with the product elements 602 have been rising, declining, or staying the same over a given time period. In the example of FIG. 6, the volume trend indicator 608A indicates that the volume score for the “Sony Bravia 46″ LED TV with Ultrabright” has been increasing. Furthermore, the volume trend indicator 608B indicates that the volume score for the “LG-47″ Class LED-LCD HDTV” has been declining. In addition, the volume trend indicator 608C indicates that the volume score for the “Panasonic VIERA 46″ Class LCD HDTV” has been staying the same.

The product elements 602 also includes sentiment bars 610A through 610C (collectively, “sentiment bars 610”). The sentiment bars 610 contain information about the sentiment scores of the products associated with the product elements 602. Particularly, in the example of FIG. 6, the sentiment bars 610 have more black boxes when the products associated with the product elements 602 have higher sentiment scores. Conversely, the sentiment bars 610 have fewer black boxes when the products associated with the product elements 602 have lower sentiment scores.

In addition, the sentiment bars 610 include sentiment trend indicators 612A through 612C (collectively, “sentiment trend indicators 612”). The sentiment trend indicators 612 indicate whether the sentiment scores for the products associated with the product elements 602 have been rising, declining, or staying the same over a given time period. In the example of FIG. 6, the sentiment trend indicator 612A indicates that the sentiment score for the “Sony Bravia 46″ LED TV with Ultrabright” has not been increasing or decreasing. Furthermore, the sentiment trend indicator 612B indicates that the sentiment score for the “LG-47″ Class LED-LCD HDTV” has been increasing. In addition, the sentiment trend indicator 612C indicates that the sentiment score for the “Panasonic VIERA 46″ Class LCD HDTV” has been decreasing.

The product comparison interface 600 also comprises sort-by controls 614. The sort-by controls 614 enable the user to select how the product elements 602 are arranged within the product comparison interface 600. In the example of FIG. 6, the product elements 602 are arranged within the product comparison interface 600 according to the product scores of the products associated with the product elements 602. When the product elements 602 are arranged within the product comparison interface 600 according to the product scores of the products associated with the product elements 602, the product elements associated with the greatest product scores are at the top left. Alternatively, the user could use the sort-by controls 614 to arrange the product elements 602 within the product comparison interface 600 on a basis of price, brand, sales volume, product age, or other factors of the products associated with the product elements 602.

Reference is now made again to FIG. 4. When the product comparison interface is displayed to the user, the aggregation server 106 receives input from the user via the product comparison interface (416). The aggregation server 106 does different things depending on the type of the input.

Accordingly, the aggregation server 106 determines if the input is a product selection input (418). In various embodiments, the aggregation server 106 can receive product selection input in various ways. In the example of FIG. 6, the aggregation server 106 can receive product selection input when the user clicks on one of the product elements 602. If the input is a product selection input (“YES” of 418), the aggregation server 106 displays a product detail interface to the user (420). The product detail interface contains additional information about the product indicated by the product selection input.

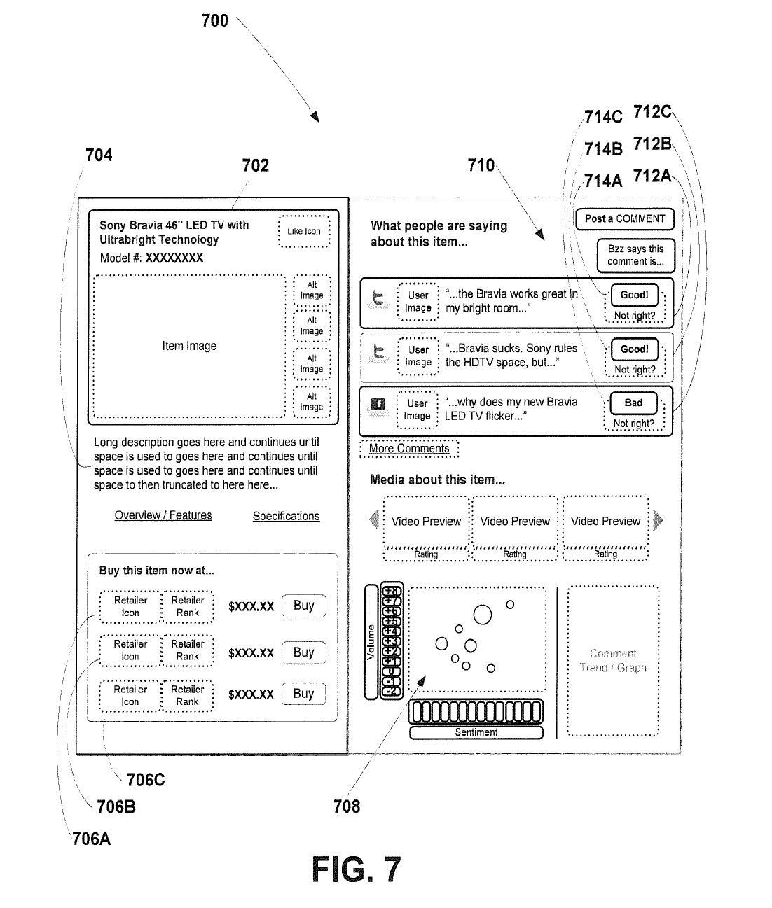

In various embodiments, the product detail interface has various elements and styles. FIG. 7 is a screen illustration showing an example product detail interface 700. It should be appreciated that in other embodiments, the product detail interface can have elements and styles different than those of the product detail interface 700.

As illustrated in the example of FIG. 7, the product detail interface 700 includes a title area 702. The title area 702 contains a title of a product and one or more pictures of the product. The product detail interface 700 also includes a long description 704 of the product. In addition, the product detail interface 700 contains retailer elements 706A through 706C (collectively, “retailer elements 706”). The retailer elements 706 include information about online retailers who sell the product. The retailer elements 706 also include prices at which the online retailers sell the product.

The product detail interface 700 contains a product map 708. The product map 708 graphically shows how the volume and sentiment scores of the product compare with the volume and sentiment scores for other similar products. Greater discussion of product maps, such as the product map 708, is provided elsewhere in this document.

In addition, the product detail interface 700 includes a feedback area 710. The feedback area 710 contains feedback elements 712A through 712C (collectively, “feedback elements 712”). The feedback elements 712 contain at least portions of the text in feedback items mentioning the product. The feedback elements 712 also identify a UGC service on which the feedback items were generated. For example, the feedback element 712A contains a portion of a feedback item posted in Twitter. In this example, the feedback element 712A states “. . . the Bravia works great in my bright room.” The feedback elements 712 can also contain information, such as a picture, associated with a user who generated the feedback item.

Although not illustrated in the example of FIG. 7 for the sake of visual clarity, the product detail interface 700 can also include additional elements. For example, the product detail interface 700 can include elements that enable the user to associate the product with one or more tags. For instance, the user could use such elements to associate the tag “fast refresh” with the product. In another example, the product detail interface 700 can include detailed information about the product, such as technical specifications of the product and overview information about the product. In yet another example, the product detail interface 700 can include features that allow the user to compare the technical specifications and product scores of the product with other products. In yet another example, the product detail interface 700 can include features that allow the user to review discussions regarding the product.

Furthermore, the feedback elements 712 include sentiment indicators 714A through 714C (collectively, “sentiment indicators 714”). The sentiment indicators 714 indicate whether the aggregation server 106 has determined the feedback items associated with the feedback elements 712 express positive, negative, or neutral sentiment toward the product. For example, the sentiment indicators 714A and 714B indicate that the aggregation server 106 has determined that the associated feedback items express positive (“Good!”) sentiment toward the product and the sentiment indicator 714C indicates that the aggregation server 106 has determined that the associated feedback item expresses negative (“Bad”) sentiment toward the product.

For a variety of reasons, the aggregation server 106 can incorrectly determine that a feedback item expresses positive, negative, or neutral sentiment toward the product. In the example of FIG. 7, the sentiment indicator 714B indicates positive sentiment toward the product. In this example, the aggregation server 106 may have detected positive sentiment because of the word “rules,” when the generally tone of the feedback item is negative. Accordingly, the product detail interface 700 enables the user to correct the sentiment associated with a feedback item. To correct the sentiments associated with the feedback items, the user can select the sentiment indicators 714. When the user selects one of the sentiment indicators 714, the aggregation server 106 displays a sentiment correction interface to the user. The sentiment correction interface enables the user to correct the sentiment assigned to the feedback item associated with the sentiment indicator.

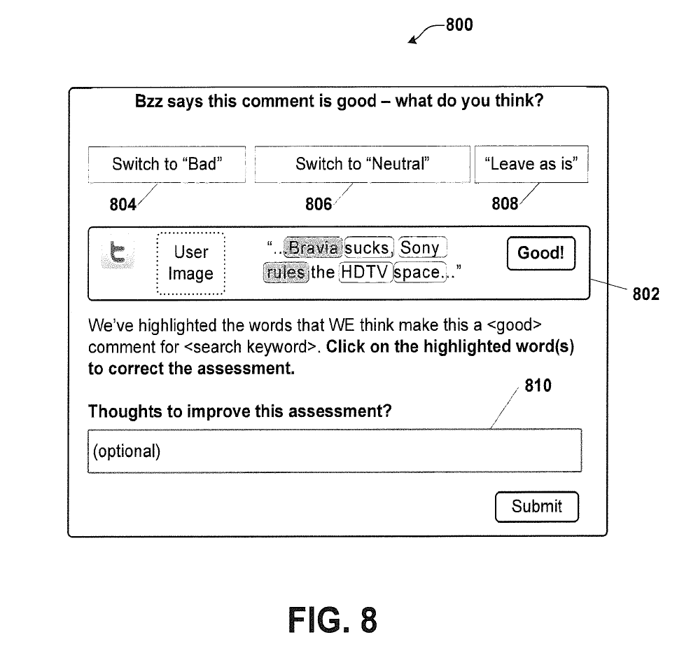

In various embodiments, the sentiment correction interface has various elements and styles. FIG. 8 is a screen illustration showing an example sentiment correction interface 800. It should be appreciated that the sentiment correction interface can have different elements and styles than the sentiment correction interface 800.

As illustrated in the example of FIG. 8, the sentiment correction interface 800 includes a text area 802. The text area 802 includes text from a feedback item. In the example of FIG. 8, the text area 802 includes the text “. . . Bravia sucks, Sony rules the HDTV space . . . ” Words in the text area 802 are highlighted in a first color if the words support the determination regarding whether the feedback item expresses favorable sentiment toward the product. In the example of FIG. 8, the words “Bravia” and “rules” are highlighted because these words support the determination that the feedback item expresses favorable sentiment toward to the product.

Furthermore, the sentiment correction interface 800 includes a “switch to bad” button 804, a “switch to neutral” button 806, and a “leave as is” button 808. The user selects the “switch to bad” button 804 to indicate that the feedback item actually expresses negative sentiment about the product. In response to the user selecting the “switch to bad” button 804, the sentiment correction interface 800 invites the user to select words in the text area 802 that support the determination that the feedback item expresses a negative sentiment toward the product. For example, the user could select the words “Bravia” and “sucks” to support the determination that the feedback item expresses a negative sentiment about the product. The user is not allowed to select words in the text area 802 that are not likely to impact the sentiment of the feedback item. Words in the text area 802 that have semantic meaning are surrounded by boxes. For instance, the user is not allowed to select the word “the.”

The user selects the “switch to neutral” button 806 to indicate that the feedback item actually expresses neutral sentiment toward the product. In response to the user selecting the “switch to neutral” button 806, the sentiment correction interface 800 invites the user to select words in the text area 802 that support the determination that the feedback item expresses neutral sentiment toward the product.

If the user has selected either the “switch to bad” button 804 or the “switch to neutral” button 806, but later changes his or her mind, the user can select the “leave as is” button 808 to restore the determination that the feedback item expresses positive sentiment toward the product. If the aggregation server 106 initially determines that the feedback item expresses negative sentiment toward the product, the “switch to bad” button 804 is replaced with a “switch to good” button. If the aggregation server 106 initially determines that the feedback item expresses neutral sentiment toward the product, the “switch to neutral” button is replaced by a “switch to good” button.

Furthermore, the sentiment correction interface 800 includes a suggestion text area 810. The user can enter suggestions for improving the determination of sentiments expressed in feedback items by entering text into the suggestion text area 810. The sentiment correction interface 800 also includes a submit button 812. The user selects the submit button 812 to submit to the aggregation server 106 his or her suggestions regarding the sentiment expressed by the feedback item.

Reference is now made again to FIG. 4. If the aggregation server 106 determines that the input is not a product selection input (“NO” of 418), the aggregation server 106 determines whether the input is a map selection input (422). The map selection input indicates that the user wants to view a product map of the products shown in the product comparison interface. In various embodiments, the aggregation server 106 receives the map selection input in various ways. In the example of FIG. 6, the aggregation server 106 can receive the map selection input when the user selects a tab 616 labeled “view results on map.”

If the aggregation server 106 determines that the input is a map selection input (“YES” of 422), the aggregation server 106 displays a map interface to the user (424). The map interface contains a product map that graphically shows how the volume and sentiment scores of the relevant products compare to one another.

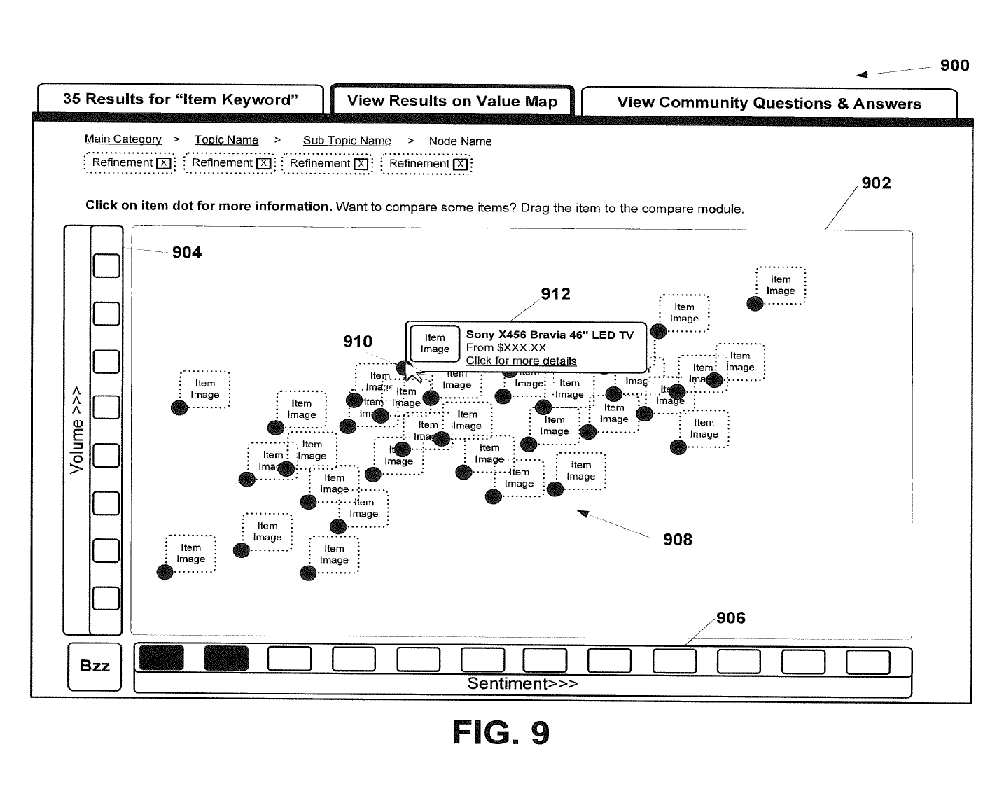

In various embodiments, the map interface has various elements and styles. FIG. 9 is a screen illustration showing an example map interface 900. It should be appreciated that the map interface can have different elements and styles than the map interface 900 illustrated in the example of FIG. 9.

As illustrated in the example of FIG. 9, the map interface 900 contains a product map 902. The product map 902 has a volume axis 904 and a sentiment axis 906. Furthermore, the product map 902 contains product points 908. Each of the product points 908 in the product map 902 is associated with a different one of the relevant products. In the example of FIG. 9, images of the products associated with the product points 908 are shown adjacent to the product points 908.

The product points 908 are positioned within the product map 902 based on the volume and sentiment scores of the products associated with the product points 908. The product points associated with products having relatively high volume scores are positioned higher along the volume axis 904 than product points associated with products having relatively low volume scores. The product points associated with products having relatively high sentiment scores are positioned to the right on the sentiment axis 906 of product points associated with products having relatively low sentiment scores. Hence, a production point associated with a product having a low volume score and a low sentiment score is positioned in the lower left of the product map 902. Similarly, a product point associated with a product having a high volume score and a high sentiment score is positioned in the upper right of the product map 902.

The user can move a cursor 910 over the product points 908. As the user moves the cursor 910 over the product points 908, the map interface 900 displays info bubbles containing information regarding the products associated with the product points 908. In the example of FIG. 9, the user has positioned the cursor 910 over a given product point associated with the “Sony X456 Bravia 46″ LED TV” product. Accordingly, the map interface 900 displays an info bubble 912 containing information about the “Sony X456 Bravia 46″ LED TV” product. The user can view a product detail page regarding the “Sony X456Bravia 46″ LED TV” product by clicking on the info bubble 912. If the user moves the cursor 910 away from the given product point and not onto the info bubble 912, the info bubble 912 disappears. Thus, by moving the cursor 910 over the product points 908, the user can compare the volume and sentiment scores for the relevant products. As an alternative to using the cursor 910, the user can indicate ones of the product points 908 by touching on the product points 908 on a touch-sensitive screen, by cycling through the product points 908 using a keyboard, or by another type of input device.

Reference is now made again to FIG. 4. If the aggregation server 106 determines that the input is not map selection input (“NO” of 422), the aggregation server 106 determines whether the input is question submission input (426). If the aggregation server 106 determines that the input is question submission input (“YES” of 426), the aggregation server 106 provides a question submission interface to the user (428). The question submission interface allows the user to submit questions regarding products to one or more other users. In some embodiments, the question submission interface is included in the product comparison interface.

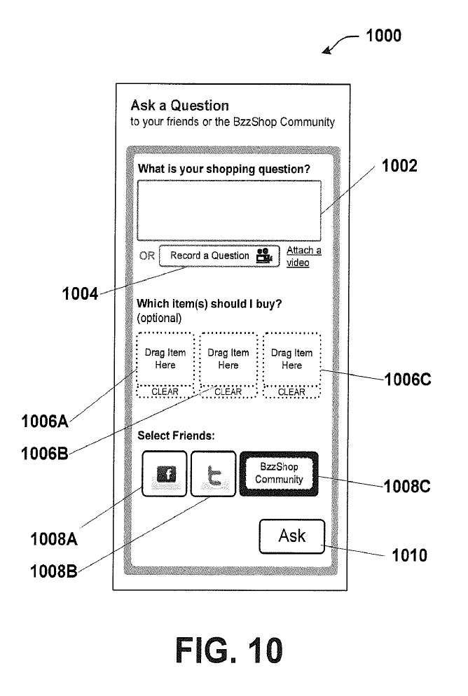

In various embodiments, the question submission interface has various elements and styles. FIG. 10 is a screen illustration showing an example question submission interface 1000. It should be appreciated that in other embodiments, the product detail interface can have elements and styles different than those of the question submission interface 1000.

As illustrated in the example of FIG. 10, the question submission interface 1000 includes a text area 1002. The user can type or otherwise enter a textual question into the text area 1002. The question submission interface 1000 also includes a button 1004. When the user selects the button 1004, the user can record an audio and/or video sample in which the user asks a question. The user can record such a sample as an alternative to entering a textual question into the text area 1002.

The question submission interface 1000 also includes drop areas 1006A through 1006C (collectively, “drop areas 1006”). The user can drag product elements from the product comparison interface into the drop areas 1006. For example, using the product comparison interface 600 illustrated in the example of FIG. 6, the user can individually drag the product elements 602 into the drop areas 1006. The user drags product elements into the drop areas 1006 as an alternative to providing a textual question using the text area 1002 or recording a question using the button 1004. Dragging multiple ones of the product elements 602 into the drop areas 1006 is equivalent to asking “which one of the products I dragged into the drop areas 1006 should I buy?” Dragging only one of the product elements 602 into one of the drop areas 1006 is equivalent to asking “should I buy this product?” In some embodiments, the user can also drag text descriptions of products into the drop areas 1006.

In addition, the question submission interface 1000 includes recipient selection elements 1008A through 1008C (collectively, “recipient selection elements 1008”). Selecting one of the recipient selection elements 1008 causes the question submission interface 1000 to display a list of potential recipients for the question. The user can then use such lists of potential recipients to select recipients of the question. For example, the recipient selection element 1008A is associated with the user's Facebook account. In this example, the question submission interface 1000 displays a list of the user's Facebook friends when the user selects the recipient selection element 1008A. Similarly, the recipient selection element 1008B is associated with the user's Twitter account. In this example, the question submission interface 1000 display a list of the user's Twitter contacts when the user selects the recipient selection element 1008B.

The recipient selection element 1008C is associated with the community of users who have profiles with the aggregation server 106. If the user selects the recipient selection element 1008C, the aggregation server 106 automatically routes the question to users of the product rank service who have claimed in their profiles to be experts in topics related to the product(s) dropped into the drop areas 1006. If one of the expert users answers the question, and the answer is provided to the user. In some embodiments, the answer is provided to the user in an interface provided by the aggregation server 106. In other embodiments, the answer is provided to the user via email, text message, or in another way. In some embodiments, the answering users can be rewarded for answering questions. For example, the answering users can get points for answers that are useful to the user. In this example, the answering users can redeem the points for purchases made through the product rank service.

The question submission interface 1000 also includes a submit button 1010. After the user selects one or more recipients using the recipient selection elements 1008, the user selects the submit button 1010. Selecting the submit button 1010 provides question submission input to the aggregation server 106.

The aggregation server 106 can provide various interfaces that show the results of questions posed by the user. For example, the aggregation server 106 can provide an interface that shows the user how many recipients of a question indicated that the user should buy a given product from a set of products, an interface that shows the user how many recipients of a question indicated that the user should or should not by a given product, and so on. In this example, the user can provide feedback indicating whether the user actually bought the given product. In another example, the aggregation server 106 can provide an interface that lists user textual or audio/video answers provided to questions submitted by the user.

Reference is now made again to FIG. 4. If the aggregation server 106 determines that the input is not question submission input (“NO” of 426), the aggregation server 106 ignores the input (430). It should be appreciated that in some embodiments the aggregation server 106 can receive inputs in addition to product selection input, map selection input, and question submission input. For example, the aggregation server 106 could also receive input when a user positions a cursor over one of the product elements 602 without selecting the product element. In this example, the aggregation server 106 could display additional details about the product associated with the product element.

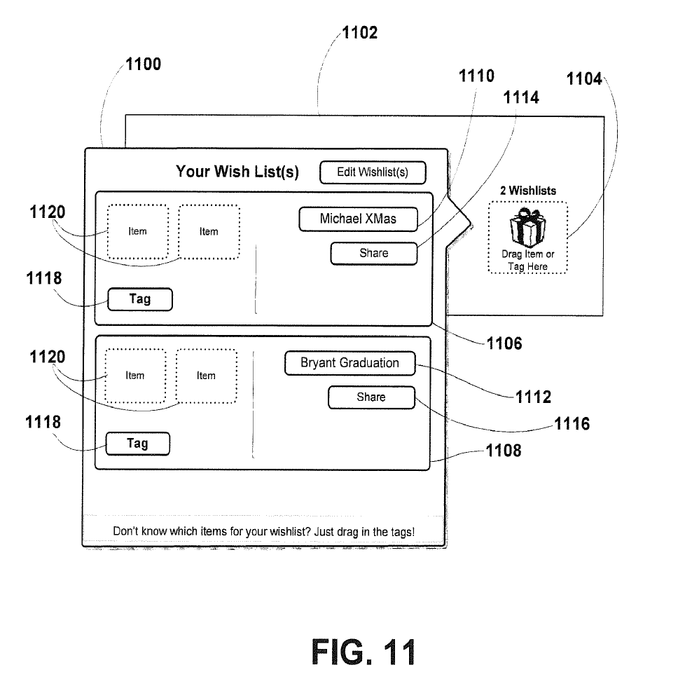

FIG. 11 is a screen illustration showing an example wishlist interface 1100. In addition to the wishlist interface 1100, FIG. 11 contains a pane 1102. In some embodiments, the pane 1102 is the search interface 500 illustrated in the example of FIG. 5. Furthermore, in some embodiments, the pane 1102 is displayed near the product comparison interface 600. For example, the pane 1102 can be displayed above the product comparison interface 600.

The pane 1102 contains a wishlist control 1104. The user is able to drag individual tags (e.g., the tags 508) from the search interface 500 and drop the tags at the wishlist control 1104. Depending on how many wishlists are associated with the user, the aggregation server 106 performs different actions when the user drops a tag at the wishlist control 1104. For example, if the user has no wishlists, the aggregation server 106 creates a new wishlist for the user and adds the tag to the new wishlist. If the user only has one wishlist, the aggregation server 106 can automatically add the tag to the wishlist. If the user has multiple wishlists, the aggregation server 106 can prompt the user to select one of the wishlists and then add the tag to the selected wishlist.

By adding tags to a wishlist, products are associated with the tags automatically become associated with the wishlist. For example, if the user adds the tags “smartphone,” “Bluetooth,” “big screen,” and “Verizon” to a wishlist, products associated with these tags automatically become associated the wishlist. Adding tags to a wishlist instead of specific products to the wishlist can be advantageous for several reasons. For instance, in the previous example, new big screen Bluetooth smartphones are frequently released for the Verizon network. Consequently, particular big screen Bluetooth smartphone models can become obsolete in a time between when the user creates the wishlist and a time when a person wants to buy such a phone for the user. The user probably does not want an obsolete smartphone. Thus, by adding the appropriate tags to the wishlist, the user is able to create a wishlist that is associated with big screen Bluetooth smartphones for the Verizon network. When people view the user's wishlist, big screen Bluetooth smartphones currently available for the Verizon network are shown in an ordered based on their current ranks. In another example, the user may want some kind of Scotch for his birthday every year. In this example, the user could associate the appropriate tags with his wishlist and other people could easily find the best Scotch for the user each year.

Furthermore, the user is able to drag individual product elements (e.g., product elements 602) from the product comparison interface 600 and drop the product elements at the wishlist control 1104. Depending on how many wishlists are associated with the user, the aggregation server 106 performs different actions when the user drops a product element at the wishlist control 1104. For example, if the user has no wishlists, the aggregation server 106 creates a new wishlist for the user and adds a product associated with the product element to the new wishlist. If the user only has one wishlist, the aggregation server 106 can automatically add the product associated with the product element to the wishlist. If the user has multiple wishlists, the aggregation server 106 can prompt the user to select one of the wishlists and then add the product associated with the product element to the selected wishlist. Thus, by dropping product elements at the wishlist control 1104, the user is able to add products to the user's wishlist(s).

In the example of FIG. 11, the user is able to select the wishlist control 1104. In various embodiments, the user selects the wishlist control 1104 in various ways. For example, the user can click on the wishlist control 1104 with a cursor, position a cursor over the wishlist control 1104, tap the wishlist control 1104 with a touchscreen interface, or otherwise select the wishlist control 1104. When the user selects the wishlist control 1104, the aggregation server 106 displays the wishlist interface 1100.

The wishlist interface 1100 allows the user to review the products and tags associated with the user's wishlists. As illustrated in the example of FIG. 11, the user has two wishlists. The products and tags associated with the user's first wishlist are shown in an area 1106. The products and tags associated with the user's second wishlist are shown in an area 1108. The areas 1106, 1108 contain naming controls 1110, 1112. When the user selects the naming controls 1110, 1112, the aggregation server 106 displays interfaces that enable the user to select names for the wishlists. In the example of FIG. 11, the user has selected the name “Michael Xmas” for the first wishlist and “Bryant Graduation” for the second wishlist.

The areas 1106, 1108 also contain share controls 1114, 1116. When the user selects the share controls 1114, 1116, the aggregation server 106 displays interfaces that enable the user to select people with which to share the first and second wishlists. In some embodiments, the aggregation server 106 displays lists of people connected to the user in one or more social networking services, such as Facebook, MySpace, and Twitter. When the user shares a wishlist with another user, the aggregation server 106 displays an interface to the other user. This interface enables the other user to review and purchase the products associated with the wishlist.

In some embodiments, the user can drag and drop tags and product elements to the areas 1106, 1108 in the wishlist interface 1100. In this way, the user can continue to add tags and products to the wishlists. Furthermore, the some embodiments, the user can remove tags and products from wishlists by selecting tag controls 1118 and product controls 1120 and dropping them outside the wishlist interface 1100. The tag controls 1118 show tags associated with the wishlists. The product controls 1120 show products associated with the wishlists.

In some embodiments, the user can make one or more of the user's wishlists public. In such embodiments, the aggregation server 106 displays interfaces containing public wishlists. Users of the product rank service can use such interfaces to review the public wishlists. The users can then indicate whether they like the public wishlists. The most liked wishlists can appear more prominently in the interfaces containing public wishlists. Furthermore, the users can directly adopt public wishlists as their own wishlists. Thus, by adopting a public wishlist, the users do not need to select tags or products on their own to create their own wishlist.

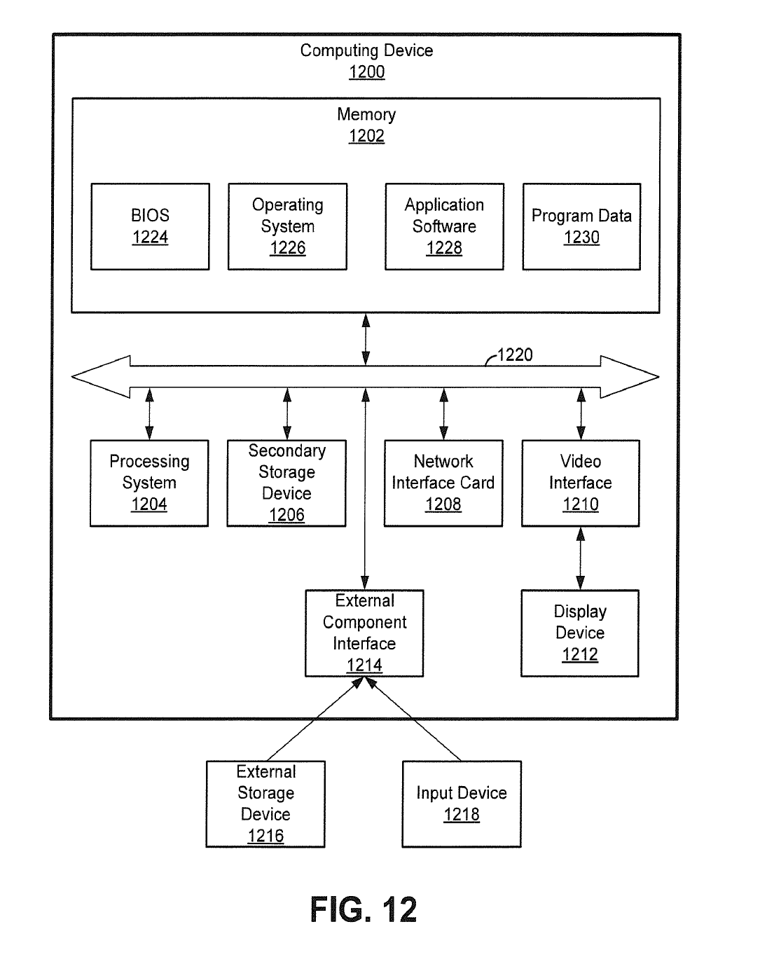

FIG. 12 is a block diagram illustrating an example computing device 1200. In some embodiments, the UGC servers 102, the client devices 104, the aggregation server 106 and/or the ecommerce servers 108 are implemented using one or more computing devices like the computing device 1200. It should be appreciated that in other embodiments, the UGC servers 102, the client devices 104, the aggregation server 106 and/or the ecommerce servers 108 are implemented using computing devices having hardware components other than those illustrated in the example of FIG. 12.

In different embodiments, computing devices are implemented in different ways. For instance, in the example of FIG. 12, the computing device 1200 comprises a memory 1202, a processing system 1204, a secondary storage device 1206, a network interface card 1208, a video interface 1210, a display device 1212, an external component interface 1214, an external storage device 1216, an input device 1218, and a communication medium 1220. In other embodiments, computing devices are implemented using more or fewer hardware components. For instance, in another example embodiment, a computing device does not include a video interface, a display device, an external storage device, or an input device.

The term computer-readable media as used herein may include computer-readable storage media. Computer-readable storage media include devices or articles of manufacture that store data and/or computer-executable instructions readable by a computing device. Computer-readable storage media can be volatile or nonvolatile and can be removable or non-removable. Computer-readable storage media can store various types of information, including computer-executable instructions, data structures, program modules, or other data. Example types of computer-readable storage media include, but are not limited to, dynamic random access memory (DRAM), double data rate synchronous dynamic random access memory (DDR SDRAM), reduced latency DRAM, DDR2 SDRAM, DDR3 SDRAM, solid state memory, flash memory, read-only memory (ROM), electrically-erasable programmable ROM, magnetic disks, magnetic tape drives, CD-ROM discs, DVD-ROM discs, Blu-Ray discs, Bernoulli cartridges, and other types of devices and/or articles of manufacture that store data.

The memory 1202 includes one or more computer-readable storage media capable of storing data and/or computer-executable instructions. In different embodiments, the memory 1202 is implemented in different ways. For instance, in various embodiments, the memory 1202 is implemented using various types of computer-readable storage media.

The term computer-readable media as may also include communication media. Computer readable instructions, data structures, program modules, or other data in a modulated data signal, such as a carrier wave or other transport mechanism, may be embodied in a communication medium. The term “modulated data signal” may describe a signal that has one or more characteristics set or changed in such a manner as to encode information in the signal. For example, communication media can include wired media such as a wired network or direct-wired connection, and wireless media such as acoustic, radio frequency (RF), infrared, and other wireless media.

The processing system 1204 includes one or more processing units. A processing unit is an integrated circuit that selectively executes computer-executable instructions. In various embodiments, the processing system 1204 is implemented in various ways. For example, the processing system 1204 can comprise one or more processing cores. In another example, the processing system 1204 can comprise one or more separate microprocessors. In yet another example, the processing system 1204 can comprise one or more ASICs that provide specific functionality. In yet another example, the processing system 1204 can provide specific functionality by using an ASIC and by executing software instructions.

The secondary storage device 1206 includes one or more computer-readable storage media. The secondary storage device 1206 stores data and software instructions not directly accessible by the processing system 1204. In other words, the processing system 1204 performs an I/O operation to retrieve data and/or software instructions from the secondary storage device 1206. In various embodiments, the secondary storage device 1206 is implemented by various types of computer-readable storage media.

The network interface card 1208 enables the computing device 1200 to send data to and receive data from a communications medium, such as a computer communication network. In different embodiments, the network interface card 1208 is implemented in different ways. For example, the network interface card 1208 can be implemented as an Ethernet interface, a fiber optic network interface, a wireless network interface (e.g., WiFi, 3G, 4G, WiMax, etc.), a modem, or another type of network interface.

The video interface 1210 enables the computing device 1200 to output video information to the display device 1212. In different embodiments, the video interface 1210 is implemented in different ways. For instance, in one example embodiment, the video interface 1210 is integrated into a motherboard of the computing device 1200. In another example embodiment, the video interface 1210 is a video expansion card.

In various embodiments, the display device 1212 is implemented as various types of display devices. Example types of display devices include, but are not limited to, cathode-ray tube displays, LCD display panels, plasma screen display panels, touch-sensitive display panels, LED screens, projectors, and other types of display devices. In various embodiments, the video interface 1210 communicates with the display device 1212 in various ways. For instance, in various embodiments, the video interface 1210 communicates with the display device 1212 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 1214 enables the computing device 1200 to communicate with external devices. In various embodiments, the external component interface 1214 is implemented in different ways. For instance, in one example embodiment, the external component interface 1214 is a USB interface. In other example embodiments, the computing device 1200 is a FireWire interface, a serial port interface, a parallel port interface, a PS/2 interface, and/or another type of interface that enables the computing device 1200 to communicate with external components.

The external storage device 1216 is an external component comprising one or more computer readable data storage media. Different implementations of the computing device 1200 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. The input device 1218 is an external component that provides user input to the computing device 1200. Different implementations of the computing device 1200 interface with different types of input devices. Example types of input devices include, but are not limited to, keyboards, mice, trackballs, stylus input devices, key pads, microphones, joysticks, touch-sensitive display screens, and other types of devices that provide user input to the computing device 1200.

The communications medium 1220 facilitates communication among the hardware components of the computing device 1200. In different embodiments, the communications medium 1220 facilitates communication among different components of the computing device 1200. For instance, in the example of FIG. 12, the communications medium 1220 facilitates communication among the memory 1202, the processing system 1204, the secondary storage device 1206, the network interface card 1208, the video interface 1210, and the external component interface 1214. In different implementations of the computing device 1200, the communications medium 1220 is implemented in different ways. For instance, in different implementations of the computing device 1200, the communications medium 1220 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1202 stores various types of data and/or software instructions. For instance, in the example of FIG. 12, the memory 1202 stores a Basic Input/Output System (BIOS) 1224, an operating system 1226, application software 1228, and program data 1230.

The BIOS 1224 includes a set of computer-executable instructions that, when executed by the processing system 1204, cause the computing device 1200 to boot up. The operating system 1226 includes a set of software instructions that, when executed by the processing system 1204, cause the computing device 1200 to provide an operating system that coordinates the activities and sharing of resources of the computing device 1200. Example types of operating systems include, but are not limited to, MICROSOFT® WINDOWS®, Linux, Unix, Apple OS X, Apple iOS, Google Chrome OS, Google Android OS, and so on. The application software 1228 includes a set of software instructions that, when executed by the processing system 1204, cause the computing device 1200 to provide applications. The program data 1230 is data generated and/or used by the application software 1228.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders.

What is claimed is:

1. A method comprising:
generating product scores for a plurality of products, the product scores for the products being based on amounts of user-generated content mentioning the products and based on how favorable the user-generated content is to the products; and
providing a product comparison interface to a consumer, the product comparison interface comprising product elements, each of the product elements comprising information about a different one of the products, the product elements arranged within the product comparison interface based on the product scores for the products.

2. A computing device comprising:
a processing system; and
a computer-readable storage medium that stores computer-readable instructions that, when executed by the processing system, cause the processing system to:
generate product scores for a plurality of products, the product scores for the products being based on amounts of user-generated content mentioning the products and based on how favorable the user-generated content is to the products; and
provide a product comparison interface to a consumer, the product comparison interface comprising product elements, each of the product elements comprising information about a different one of the products, the product elements arranged within the product comparison interface based on the product scores for the products.

3. A computer-readable storage medium comprising instructions that, when executed by a processing unit of a computing device, cause the computing device to:
generate product scores for a plurality of products, the product scores for the products being based on amounts of user-generated content mentioning the products and based on how favorable the user-generated content is to the products; and
provide a product comparison interface to a consumer, the product comparison interface comprising product elements, each of the product elements comprising information about a different one of the products, the product elements arranged within the product comparison interface based on the product scores for the products.
